(19) United States
(12) Patent Application Publication
(10) Pub. No.: US 2025/0289428 A1
(43) Pub. Date: Sep. 18, 2025

(54) VEHICLE DRIVER-ASSISTANCE DEVICE

(71) Applicant: TOYOTA JIDOSHA KABUSHIKI KAISHA, Toyota-shi (JP)

(72) Inventor: Hiroki TERASHITA, Susono-shi (JP)

(73) Assignee: TOYOTA JIDOSHA KABUSHIKI KAISHA, Toyota-shi (JP)

(21) Appl. No.: 19/014,877

(22) Filed: Jan. 9, 2025

(30) Foreign Application Priority Data
Mar. 14, 2024 (JP) 2024-040332

(51) Int. Cl. B60W 30/165; B60W 40/13

(52) U.S. Cl. CPC B60W 30/165; B60W 40/13; B60W 2510/244; B60W 2520/10; B60W 2530/16; B60W 2552/15; B60W 2554/802

(57) ABSTRACT

A vehicle driver-assistance device selectively executes first following drive control and second following drive control. The vehicle driver-assistance device acquires an energy consumption amount when it is assumed that each of the first following drive control and the second following drive control has been executed, based on at least one of the air resistance of the own vehicle, the gradient of a road on which the own vehicle is scheduled to travel, the weight of the own vehicle, and the amount of electric power consumed by the own vehicle, and executes the control out of the first following drive control and the second following drive control that consumes less energy.

### CROSS-REFERENCE TO RELATED APPLICATION

This application claims priority to Japanese Patent Application No. 2024-040332 filed on Mar. 14, 2024, incorporated herein by reference in its entirety.

### BACKGROUND

### 1. Technical Field

The disclosure relates to a vehicle driver-assistance device.

### 2. Description of Related Art

A vehicle driver-assistance device is known which selectively executes, as driver-assistance control, first following drive control for causing an own vehicle to drive autonomously such that the inter-vehicle distance between the own vehicle and a preceding vehicle is maintained at a set inter-vehicle distance, and second following drive control for causing the own vehicle to drive autonomously while allowing the inter-vehicle distance to vary within a set inter-vehicle distance range. As such a vehicle driver-assistance device is also known a vehicle driver-assistance device in which in a case of requesting execution of driver-assistance control, the amount of energy to be consumed by an entire own vehicle when it is assumed that the first following drive control has been executed (first energy consumption amount) is acquired based on the air resistance of the own vehicle, and the amount of energy to be consumed by the entire own vehicle when it is assumed that the second following drive control has been executed (second energy consumption amount) is acquired based on the air resistance of the own vehicle, and the first following drive control is executed when the first energy consumption amount is equal to or less than the second energy consumption amount, whereas the second following drive control is executed when the second energy consumption amount is smaller than the first energy consumption amount (see, for example, Japanese Unexamined Patent Application Publication No. 2023-109355 (JP 2023-109355 A)). As a result, the driver-assistance control in which the amount of energy to be consumed by the entire own vehicle is smaller is executed.

### SUMMARY

The conventional vehicle driver-assistance device described above acquires the first energy consumption amount and the second energy consumption amount based on the air resistance of the own vehicle. However, it would be possible to more accurately acquire the amount of energy to be consumed by the entire own vehicle if the first energy consumption amount and the second energy consumption amount are acquired while taking into account parameters other than the air resistance of the own vehicle as parameters that affect the amount of energy to be consumed by the entire own vehicle, so that it is possible to select and execute the driver-assistance control in which the amount of energy to be consumed by the entire own vehicle is smaller.

An object of the present disclosure is to provide a vehicle driver-assistance device that can select and execute driver-assistance control in which the amount of energy to be consumed by an entire own vehicle is smaller.

A vehicle driver-assistance device according to the present disclosure includes a control device that selectively executes, as driver-assistance control, first following drive control for causing an own vehicle to autonomously drive such that the inter-vehicle distance between the own vehicle and a preceding vehicle is maintained at a set inter-vehicle distance, and second following drive control for causing the own vehicle to autonomously drive while allowing the inter-vehicle distance to vary within a set inter-vehicle distance range. In a case of requesting execution of the driver-assistance control, the control device acquires, based on the air resistance of the own vehicle, the amount of energy to be consumed by the entire own vehicle as a first energy consumption amount when it is assumed that the first following drive control has been executed, and acquires, based on the air resistance, the amount of energy to be consumed by the entire own vehicle as a second energy consumption amount when it is assumed that the second following drive control has been executed. Furthermore, the control device is configured to execute the first following drive control when the first energy consumption amount is equal to or less than the second energy consumption amount, and execute the second following drive control when the second energy consumption amount is smaller than the first energy consumption amount. The control device is configured to acquire the first energy consumption amount and the second energy consumption amount based on at least one of the gradient of a road on which the own vehicle is scheduled to travel, the weight of the own vehicle, and the amount of electric power consumed by the own vehicle in addition to the air resistance.

According to the vehicle driver-assistance device of the present disclosure, the first energy consumption amount and the second energy consumption amount are acquired by using at least one of the gradient of the road on which the own vehicle is scheduled to travel, the weight of the own vehicle, and the amount of electric power consumed by the own vehicle in addition to the air resistance of the own vehicle as parameters affecting the amount of energy to be consumed by the entire own vehicle. Therefore, it is possible to more accurately acquire the amount of energy which will be consumed by the entire own vehicle when the first following drive control is executed, and the amount of energy which will be consumed by the entire own vehicle when the second following drive control is executed. Therefore, it is possible to select and execute the driver-assistance control that causes the entire own vehicle to consume less energy.

In the vehicle driver-assistance device according to the present disclosure, the control device may be configured to acquire the transition of the air resistance as a first air resistance transition based on the size of the preceding vehicle, the transition of the vehicle speed of the own vehicle when it is assumed that the first following drive control has been executed, and the transition of the inter-vehicle distance when it is assumed that the first following drive control has been executed, acquire the transition of a gradient resistance of the own vehicle as a first gradient resistance transition based on the gradient and the weight, acquire a rolling resistance of the own vehicle as a first rolling resistance based on the weight, acquire the transition of an acceleration resistance of the own vehicle as a first acceleration resistance transition based on the weight and the transition of an acceleration of the own vehicle when it is assumed that the first following drive control has been executed, and acquire the first energy consumption amount based on the first air resistance transition, the first gradient resistance transition, the first rolling resistance, the first acceleration resistance transition, and the amount of electric power. In this case, the control device may be configured to acquire the transition of the air resistance as a second air resistance transition based on the size of the preceding vehicle, the transition of the vehicle speed of the own vehicle when it is assumed that the second following drive control has been executed, and the transition of the inter-vehicle distance when it is assumed that the second following drive control has been executed, acquire the transition of the gradient resistance of the own vehicle as a second gradient resistance transition based on the gradient and the weight, acquire a rolling resistance of the own vehicle as a second rolling resistance based on the weight, acquire the transition of an acceleration resistance of the own vehicle as a second acceleration resistance transition based on the weight and the transition of the acceleration of the own vehicle when it is assumed that the second following drive control has been executed, and acquire the second energy consumption amount based on the second air resistance transition, the second gradient resistance transition, the second rolling resistance, the second acceleration resistance transition, and the amount of electric power.

According to the vehicle driver-assistance device of the present disclosure, the first energy consumption amount and the second energy consumption amount are acquired based on the transition of the air resistance, the transition of the gradient resistance, the rolling resistance, the transition of the acceleration, and the amount of electric power. Therefore, it is possible to more accurately acquire the first energy consumption amount and the second energy consumption amount.

The components of the present disclosure are not limited to those of the embodiment of the present disclosure described below with reference to the drawings. Other objects, features and concomitant advantages of the present disclosure will be easily understood from the description of the embodiment of the present disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a vehicle driver-assistance device according to an embodiment of the present disclosure;

FIG. 2 is a flowchart showing a routine to be executed by the vehicle driver-assistance device according to the embodiment of the present disclosure; and

FIG. 3 is a diagram showing a scene in which a preceding vehicle is present ahead of an own vehicle.

### DETAILED DESCRIPTION OF EMBODIMENTS

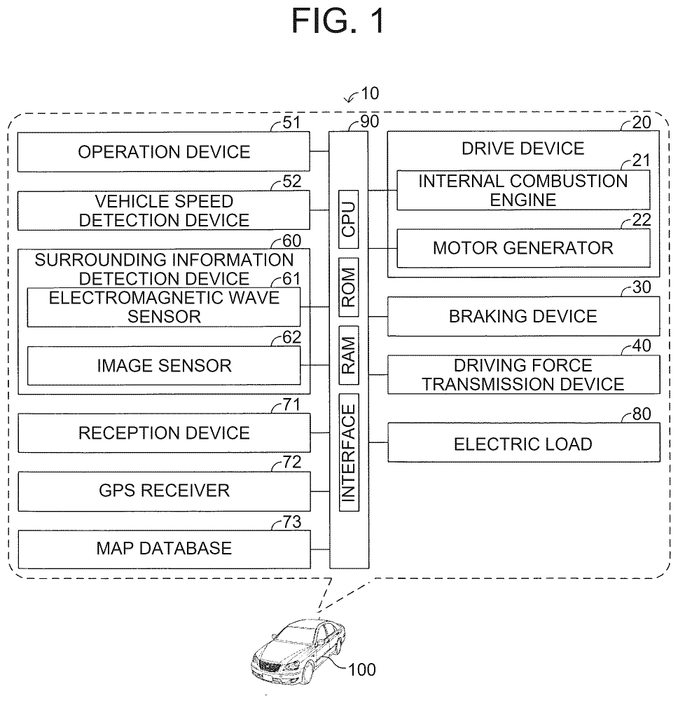

A vehicle driver-assistance device according to an embodiment of the present disclosure will be described hereunder with reference to the drawings. FIG. 1 shows a vehicle driver-assistance device 10 according to the embodiment of the present disclosure. The vehicle driver-assistance device 10 is mounted in an own vehicle 100. The vehicle driver-assistance device 10 will be described hereunder by illustrating a case in which an operator of the own vehicle 100 is a person who gets in the own vehicle 100 and drives the own vehicle 100 (that is, a driver of the own vehicle 100).

However, the operator of the own vehicle 100 may be a person who drives the own vehicle 100 remotely without getting in the own vehicle 100 (that is, a remote operator of the own vehicle 100). When the operator of the own vehicle 100 is a remote operator, the vehicle driver-assistance device 10 is mounted in each of the own vehicle 100 and a remote operation facility which is installed outside the own vehicle 100 to remotely drive the own vehicle 100, and the functions of the vehicle driver-assistance device 10 described below are shared and performed by the vehicle driver-assistance device 10 mounted in the own vehicle 100 and the vehicle driver-assistance device 10 mounted in the remote operation facility.

As shown in FIG. 1, the vehicle driver-assistance device 10 includes an electronic control device (ECU) 90 as a control device. The ECU 90 includes a microcomputer as a main component. The microcomputer includes CPU, storage media such as ROM, RAM, and a non-volatile memory, an interface and the like. The CPU executes instructions, programs, or routines stored in the storage media to implement various functions. In particular, in the present example, the vehicle driver-assistance device 10 stores, in the storage media, programs for implementing various control to be executed by the vehicle driver-assistance device 10.

In the present example, the vehicle driver-assistance device 10 has only one ECU 90, but it may also be configured to have a plurality of ECUs such that the respective ECUs share and execute the functions of the vehicle driver-assistance device 10 described below.

Furthermore, the vehicle driver-assistance device 10 may be configured to be able to update the programs stored in the storage medium through wireless communication with an external device (for example, Internet communication).

As shown in FIG. 1, the own vehicle 100 is equipped with a drive device 20, a braking device 30, and a driving force transmission device 40. The drive device 20 includes an internal combustion engine 21 and a motor generator 22. The internal combustion engine 21, the motor generator 22, the braking device 30, and the driving force transmission device 40 are each electrically connected to the ECU 90.

The drive device 20 is a device for generating driving force to be applied to the own vehicle 100 (particularly, drive wheels of the own vehicle 100). The vehicle driver-assistance device 10 can control the driving force to be output from the own vehicle 100 by controlling the operation of the drive device 20 (more specifically, the operation of the internal combustion engine 21 and the operation of the motor generator 22).

The braking device 30 is a device for applying braking force to the own vehicle 100 (particularly, the wheels of the own vehicle 100), and includes, for example, a hydraulic braking device. The vehicle driver-assistance device 10 can control the braking force to be applied to the own vehicle 100 by controlling the operation of the braking device 30.

The driving force transmission device 40 is a device for transmitting the driving force output from the drive device 20 to the drive wheels of the own vehicle 100, and is, for example, a transmission. By controlling the operation of the driving force transmission device 40, the vehicle driver-assistance device 10 can establish a path (driving force transmission path) for transmitting the driving force from the drive device 20 to the drive wheels of the own vehicle 100 and transmit the driving force output from the drive device 20 to the drive wheels of the own vehicle 100, or cut off the driving force transmission path to prevent the driving force from being transmitted from the drive device 20 to the drive wheels of the own vehicle 100.

Furthermore, the own vehicle 100 is equipped with an operation device 51, a vehicle speed detection device 52, a surrounding information acquisition device 60, a reception device 71, a GPS receiver 72, and a map database 73. The surrounding information acquisition device 60 includes an electromagnetic wave sensor 61 such as a radar sensor, and an image sensor 62 such as a camera sensor. The operation device 51, the vehicle speed detection device 52, the electromagnetic wave sensor 61, the image sensor 62, the reception device 71, the GPS receiver 72, and the map database 73 are each electrically connected to the ECU 90.

The operation device 51 is a device to be operated by the driver of the own vehicle 100. By operating the operation device 51, the driver can request the vehicle driver-assistance device 10 to execute driver-assistance control described later.

The vehicle speed detection device 52 is a device for detecting the traveling speed of the own vehicle 100, and includes, for example, wheel speed sensors each of which is provided on each corresponding wheel of the own vehicle 100. The vehicle driver-assistance device 10 obtains the traveling speed of the own vehicle 100 as an own vehicle speed Vego by the vehicle speed detection device 52.

The surrounding information acquisition device 60 is a device for acquiring information on the surroundings of the own vehicle 100 as surrounding information IS. The vehicle driver-assistance device 10 acquires data on objects present in the surroundings of the own vehicle 100 (object information) as the surrounding information IS by using the electromagnetic wave sensor 61. Furthermore, the vehicle driver-assistance device 10 acquires image data (image information) of a forward area of the own vehicle 100 as the surrounding information IS by using the image sensor 62.

The reception device 71 is a device for receiving information transmitted from a data center installed outside the own vehicle 100. The vehicle driver-assistance device 10 acquires, as the surrounding information IS, the information transmitted from the data center via the reception device 71. The information includes, for example, information on the slope of the road.

The GPS receiver 72 is a device for receiving a GPS signal. The map database 73 is a database related to map information. The vehicle driver-assistance device 10 acquires the GPS signal via the GPS receiver 72, acquires the current position of the own vehicle 100 based on the acquired GPS signal, and acquires, the surrounding information IS, information related to roads (road information) around the current position of the own vehicle 100 from the map database 73 based on the acquired current position.

The own vehicle 100 is also equipped with an electric load 80 such as an air conditioner. The electric load 80 is electrically connected to the ECU 90. The vehicle driver-assistance device 10 is configured to be capable of controlling the operation of the electric load 80. The vehicle driver-assistance device 10 is also configured to be capable of measuring the amount of electric power consumed by the electric load 80.

### Operation of Vehicle Driver-Assistance Device

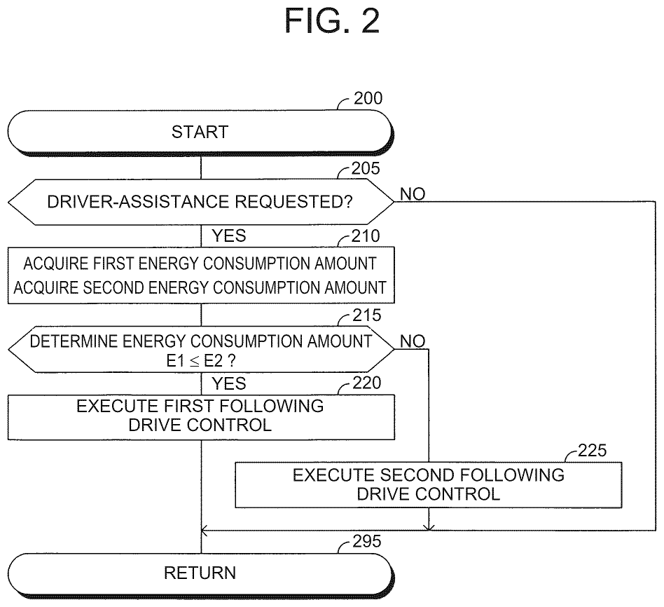

Next, the operation of the vehicle driver-assistance device 10 will be described. The vehicle driver-assistance device 10 is configured to execute the first following drive control and the second following drive control as autonomous drive control or driver-assistance control when a predetermined condition is satisfied by performing a routine shown in FIG. 2 at predetermined time intervals.

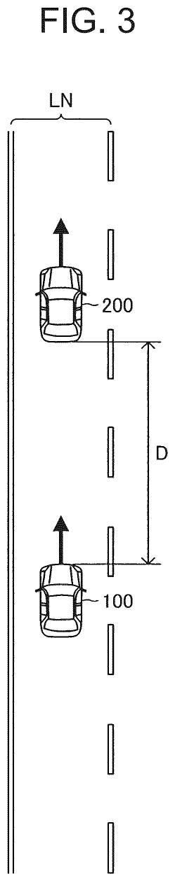

The first following drive control is control for causing the own vehicle 100 to drive autonomously such that the inter-vehicle distance D is maintained at a set inter-vehicle distance Dset when a preceding vehicle 200 is present as shown in FIG. 3. In other words, the first following drive control is control for causing the own vehicle 100 to drive autonomously so as to follow the preceding vehicle 200.

The inter-vehicle distance D is the distance between the own vehicle 100 and the preceding vehicle 200. The preceding vehicle 200 is a vehicle which travels in an own vehicle driving lane LN ahead of the own vehicle 100, and exists within a predetermined inter-vehicle distance Dth from the own vehicle 100. The own vehicle driving lane LN is a lane in which the own vehicle 100 is traveling. The vehicle driver-assistance device 10 detects the preceding vehicle 200 based on the surrounding information IS, and acquires the distance between the preceding vehicle 200 and the own vehicle 100 as the inter-vehicle distance D based on the surrounding information IS.

The second following drive control is control for causing the own vehicle 100 to drive autonomously while allowing the inter-vehicle distance D to vary within the set inter-vehicle distance range Rset when the preceding vehicle 200 is present. More specifically, the second following drive control is control for causing the own vehicle 100 to drive autonomously by selectively executing power running control and coasting control while allowing the inter-vehicle distance D to vary within the set inter-vehicle distance range Rset. In the present example, the second following drive control is control for executing the coasting control to decelerate the own vehicle 100 when the inter-vehicle distance D decreases and reaches a lower limit value of the set inter-vehicle distance range Rset, and executing the power running control to accelerate the own vehicle 100 when the inter-vehicle distance D increases and reaches an upper limit value of the set inter-vehicle distance range Rset. Therefore, the second following drive control is control for causing the own vehicle 100 to drive autonomously so as to follow the preceding vehicle 200.

The power running control is control for causing the own vehicle 100 to drive with power running. More specifically, it is control for causing the own vehicle 100 to run while applying driving force to the own vehicle 100. In the present example, the vehicle driver-assistance device 10 may operate the drive device 20 such that driving force capable of accelerating the own vehicle 100 is applied to the own vehicle 100 during execution of the power running control, or may execute optimal power running control as the power running control.

The optimal power running control is control for causing the own vehicle 100 to drive with power running by operating the internal combustion engine 21 at an optimal operating point where the operating efficiency of the internal combustion engine 21 for applying driving force to the own vehicle 100 is maximized or at an operating point where the operating efficiency is approximately maximized.

The coasting control is control for causing the own vehicle 100 to coast. In the present example, the coasting control is control for controlling the operation of the driving force transmission device 40 to cut off a path (driving force transmission path) for transmitting driving force from the drive device 20 to the driving wheels of the own vehicle 100. During execution of the coasting control, the vehicle driver-assistance device 10 may stop the operation of the internal combustion engine 21 or may operate the internal combustion engine 21 in an idling state.

In the present example, the set inter-vehicle distance range Rset is set to a range in which the lower limit value thereof is set to the set inter-vehicle distance Dset and the upper limit value thereof is set to a distance which is longer than the set inter-vehicle distance Dset by a predetermined distance AD.

At a predetermined timing, the vehicle driver-assistance device 10 starts processing from step S200 of a routine shown in FIG. 2, and advances the processing to step S205 to determine whether execution of driver-assistance control is requested. If the vehicle driver-assistance device 10 determines “No” in step S205, the vehicle driver-assistance device 10 directly advances the processing to step S295 and temporarily ends the processing of this routine. In this case, the driver-assistance control is not performed.

On the other hand, if the vehicle driver-assistance device 10 determines “Yes” in step S205, the vehicle driver-assistance device 10 advances the processing to step S210 to acquire a first energy consumption amount E1 and a second energy consumption amount E2.

The first energy consumption amount E1 is the total amount of energy to be consumed by the entire own vehicle 100 while the own vehicle 100 travels only a predetermined distance Dtra when it is assumed that the own vehicle 100 has been caused to travel only the predetermined distance Dtra by the first following drive control. The predetermined distance Dtra is a distance (or an integer multiple of the distance) by which the own vehicle 100 has traveled from the start of power running control until the end of coasting control when it is assumed that the second following drive control has been executed.

The vehicle driver-assistance device 10 acquires the first energy consumption amount E1 based on the running resistance RT of the own vehicle 100 and the electric power consumption Econ of the own vehicle 100 when it is assumed that the first following drive control has been executed. More specifically, the vehicle driver-assistance device 10 acquires the first energy consumption amount E1 as follows.

The running resistance RT is composed of a rolling resistance RR of the own vehicle 100, an air resistance Rair of the own vehicle 100, a gradient resistance RO of the own vehicle 100, and an acceleration resistance Racc of the own vehicle 100.

The vehicle driver-assistance device 10 acquires a rolling resistance RR at each predetermined time t(k) according to the following formula 1 when it is assumed that the first following drive control has been executed. In other words, the vehicle driver-assistance device 10 acquires the transition of the rolling resistance RR when it is assumed that the first following drive control has been executed. Here, the predetermined time t(k) is a time of a period of time (predetermined period of time Ttra) for which the own vehicle 100 has traveled only a predetermined distance Dtra, and the respective times are set at predetermined time intervals ΔT. Furthermore, in the following formula 1, “RR” represents the rolling resistance, “RRC” represents the rolling resistance coefficient, “Wego” represents the weight of the own vehicle 100, and “g” represents the gravitational acceleration.

RR=RRC· Wego·g (1)

Furthermore, the vehicle driver-assistance device 10 applies a vertical cross-sectional area Aver (size) of the preceding vehicle 200, the own vehicle speed Vego, and the inter-vehicle distance D to an air resistance map MAPair prepared in advance to acquire the air resistance Rair at each predetermined time t(k) when it is assumed that the first following drive control has been executed. In other words, the vehicle driver-assistance device 10 acquires the transition of the air resistance Rair when it is assumed that the first following drive control has been executed. The own vehicle speed Vego used at this time is an own vehicle speed Vego at each predetermined time t(k) which is predicted to be implemented when it is assumed that the first following drive control has been executed. Furthermore, the inter-vehicle distance D used at this time is an inter-vehicle distance D at each predetermined time t(k) which is predicted to be implemented when it is assumed that the first following drive control has been executed, and is particularly a set inter-vehicle distance Dset. The vertical cross-sectional area Aver of the preceding vehicle 200 is the area of the preceding vehicle 200 on a plane perpendicular to an axial line in the front-rear direction of the preceding vehicle 200.

Since the air resistance Rair is smaller as the vertical cross-sectional area Aver is larger, so that the air resistance Rair trends to be smaller as the own vehicle speed Vego is lower, and trends to be smaller as the inter-vehicle distance D is shorter.

Furthermore, the vehicle driver-assistance device 10 acquires a gradient resistance Rθ at each predetermined time t(k) according to the following formula 2 when it is assumed that the first following drive control has been executed. In other words, the vehicle driver-assistance device 10 acquires the transition of the gradient resistance Re when it is assumed that the first following drive control has been executed. In the following formula 2, “Rθ” represents the gradient resistance, “Wego” represents the weight of the own vehicle 100, “g” represents the gravitational acceleration, and “θroad” represents a road gradient. The road gradient θroad is equal to zero when the road is flat, takes a positive value when the road is uphill, and takes a negative value when the road is downhill. The road gradient θroad used at this time is a gradient at each predetermined time t(k) of a road on which the own vehicle 100 is scheduled to travel by only the predetermined distance Dtra under the first following drive control. The vehicle driver-assistance device 10 acquires the road gradient θroad based on the surrounding information IS.

Rθ=Wego·g·θroad (2)

Note that the gradient resistance Rθ is equal to zero when the road gradient θroad is equal to zero, takes a positive value when the road gradient θroad is equal to a positive value, and takes a negative value when the road gradient θroad is equal to a negative value.

Furthermore, the vehicle driver-assistance device 10 acquires an acceleration resistance Racc at each predetermined time t(k) according to the following formula 3 when it is assumed that the first following drive control has been executed. In other words, the vehicle driver-assistance device 10 acquires the transition of the acceleration resistance Racc when it is assumed that the first following drive control has been executed. In the following formula 3, “Racc” represents the acceleration resistance, “Gacc” represents the acceleration of the own vehicle 100, “Wego” represents the weight of the own vehicle 100, and “IM” represents an equivalent inertia weight. The acceleration Gacc of the own vehicle 100 used at this time is an acceleration of the own vehicle 100 at each predetermined time t(k) which is predicted to occur while the own vehicle 100 is caused to travel only the predetermined distance Dtra by the first following drive control.

Racc=Gacc·(Wego+IM) (3)

Note that in the present example, the acceleration resistance Racc is equal to zero when the acceleration Gacc is equal to or less than zero.

Furthermore, the vehicle driver-assistance device 10 acquires the amount of electric power consumed by an electric load 80 as an electric power consumption amount Econ at each predetermined time t(k) when it is assumed that the first following drive control has been executed. In other words, the vehicle driver-assistance device 10 acquires the transition of the electric power consumption amount Econ when it is assumed that the first following drive control has been executed. The electric power consumption amount Econ acquired at this time is the amount of electric power at each predetermined time t(k) which is predicted to be consumed by the electric load 80 while the own vehicle 100 travels only the predetermined distance Dtra under the first following drive control. The vehicle driver-assistance device 10 acquires the electric power consumption amount Econ based on the amount of electric power currently consumed by the electric load 80.

The vehicle driver-assistance device 10 applies the acquired rolling resistance RR, air resistance Rair, gradient resistance Rθ, acceleration resistance Racc, and electric power consumption amount Econ to a first energy consumption amount map MAPI to acquire the energy consumption amount at each predetermined time t(k) as a first unit consumption amount E1unit. The vehicle driver-assistance device 10 then sums up these acquired first unit consumption amounts E1unit to acquire the first energy consumption amount E1. In other words, the vehicle driver-assistance device 10 acquires the transition of the energy consumption amount from the current time until the time when the own vehicle 100 has traveled by only the predetermined distance Dtra under the first following drive control, and integrates the transition over time to acquire the first energy consumption amount E1.

On the other hand, the second energy consumption amount E2 is the total amount of energy consumed by the entire own vehicle 100 while the own vehicle 100 travels only the predetermined distance Dtra when it is assumed that the own vehicle 100 has been caused to travel only the predetermined distance Dtra by the second following drive control.

The vehicle driver-assistance device 10 acquires the second energy consumption amount E2 based on the running resistance RT of the own vehicle 100 and the electric power consumption amount Econ of the own vehicle 100 when it is assumed that the second following drive control has been executed. More specifically, the vehicle driver-assistance device 10 acquires the second energy consumption amount E2 as follows.

The vehicle driver-assistance device 10 acquires, according to the formula 1, the rolling resistance RR at each predetermined time t(k) when it is assumed that the second following drive control has been executed. In other words, the vehicle driver-assistance device 10 acquires the transition of the rolling resistance RR when it is assumed that the second following drive control has been executed.

Furthermore, the vehicle driver-assistance device 10 applies the vertical cross-sectional area Aver (size) of the preceding vehicle 200, the own vehicle speed Vego, and the inter-vehicle distance D to the air resistance map MAPair to acquire the air resistance Rair at each predetermined time t(k) when it is assumed that the second following drive control has been executed. In other words, the vehicle driver-assistance device 10 acquires the transition of the air resistance Rair when it is assumed that the second following drive control has been executed. The own vehicle speed Vego used at this time is an own vehicle speed Vego at each predetermined time t(k) which is predicted to be implemented when it is assumed that the second following drive control has been executed. Furthermore, the inter-vehicle distance D used at this time is an inter-vehicle distance D at each predetermined time t(k) which is predicted to be implemented when it is assumed that the second following drive control has been executed.

Furthermore, the vehicle driver-assistance device 10 acquires the gradient resistance Rθ at each predetermined time t(k) according to the formula 2 when it is assumed that the second following drive control has been executed. In other words, the vehicle driver-assistance device 10 acquires the transition of the gradient resistance Rθ when it is assumed that the second following drive control has been executed. The road gradient θroad used at this time is a gradient at each predetermined time t(k) of a road on which the own vehicle 100 is scheduled to travel while the own vehicle 100 travels only the predetermined distance Dtra under the second following drive control.

Furthermore, the vehicle driver-assistance device 10 acquires the acceleration resistance Racc at each predetermined time t(k) according to the formula 3 when it is assumed that the second following drive control has been executed. In other words, the vehicle driver-assistance device 10 acquires the transition of the acceleration resistance Racc when it is assumed that the second following drive control has been executed. The acceleration Gacc of the own vehicle 100 used at this time is an acceleration of the own vehicle 100 at each predetermined time t(k) which is predicted to occur while the own vehicle 100 travels only the predetermined distance Dtra under the second following drive control.

Furthermore, the vehicle driver-assistance device 10 acquires the amount of electric power consumed by the electric load 80 as an electric power consumption amount Econ at each predetermined time t(k) when it is assumed that the second following drive control has been executed. In other words, the vehicle driver-assistance device 10 acquires the transition of the electric power consumption amount Econ when it is assumed that the second following drive control has been executed. The electric power consumption amount Econ acquired at this time is the amount of electric power at each predetermined time t(k) which is predicted to be consumed by the electric load 80 while the own vehicle 100 is caused to travel only the predetermined distance Dtra by the second following drive control. The vehicle driver-assistance device 10 acquires the electric power consumption amount Econ based on the amount of electric power which is currently consumed by the electric load 80.

The vehicle driver-assistance device 10 applies the acquired rolling resistance RR, air resistance Rair, gradient resistance Rθ, acceleration resistance Racc, and electric power consumption amount Econ to a second energy consumption amount map MAP2 to acquire the energy consumption amount at each predetermined time t(k) as a second unit consumption amount E2unit. The vehicle driver-assistance device 10 then sums up these acquired second unit consumption amounts E2unit to acquire acquires the second energy consumption amount E2. In other words, the vehicle driver-assistance device 10 acquires the transition of the energy consumption amount from the current time until the time when the own vehicle 100 has traveled only the predetermined distance Dtra under the second following drive control, and acquires integrates the transition over time to acquire the second energy consumption amount E2.

In this way, the vehicle driver-assistance device 10 is configured to acquire the first energy consumption amount E1 and the second energy consumption amount E2 based on at least one of the gradient of the road on which the own vehicle 100 is scheduled to travel (road gradient road), the weight Wego of the own vehicle 100, and the amount of electric power consumed by the own vehicle 100 (power consumption amount Econ) in addition to the air resistance Rair of the own vehicle 100.

Next, the vehicle driver-assistance device 10 advances the processing to step S215 to determine whether the first energy consumption amount E1 is equal to or less than the second energy consumption amount E2.

If the vehicle driver-assistance device 10 determines “Yes” in step S215, the vehicle driver-assistance device 10 advances the processing to step S220 to execute the first following drive control. Next, the vehicle driver-assistance device 10 advances the processing to step S295 to temporarily end the processing of this routine.

On the other hand, if the vehicle driver-assistance device 10 determines “No” in step S215, the vehicle driver-assistance device 10 advances the processing to step S225 to execute the second following drive control. Next, the vehicle driver-assistance device 10 advances the processing to step S295 to temporarily end the processing of this routine.

The foregoing is the operation of the vehicle driver-assistance device 10.

According to the vehicle driver-assistance device 10, the first energy consumption amount E1 and the second energy consumption amount E2 are acquired by using the gradient of the road on which the own vehicle 100 is scheduled to travel (road gradient θroad), the weight Wego of the own vehicle 100, and the amount of electric power consumed by the own vehicle 100 (electric power consumption amount Econ) in addition to the air resistance Rair of the own vehicle 100 as parameters affecting the amount of energy consumed by the entire own vehicle 100. Therefore, it is possible to more accurately acquire the amount of energy which will be consumed by the entire own vehicle 100 when the first following drive control is executed and the amount of energy which will be consumed by the entire own vehicle 100 when the second following drive control is executed. Therefore, it is possible to select and execute the driver-assistance control that causes the entire own vehicle 100 to consume less energy.

The present disclosure is not limited to the above-described embodiment, and various modifications can be made within the scope of the present disclosure.

What is claimed is:

1. A vehicle driver-assistance device comprising a control device that selectively executes, as driver-assistance control, first following drive control for causing an own vehicle to autonomously drive such that an inter-vehicle distance between the own vehicle and a preceding vehicle is maintained at a set inter-vehicle distance, and second following drive control for causing the own vehicle to autonomously drive while allowing the inter-vehicle distance to vary within a set inter-vehicle distance range, the control device being configured to:
in a case of requesting execution of the driver-assistance control, acquire, based on air resistance of the own vehicle, an amount of energy to be consumed by the entire own vehicle as a first energy consumption amount when it is assumed that the first following drive control has been executed, and acquire, based on the air resistance, an amount of energy to be consumed by the entire own vehicle as a second energy consumption amount when it is assumed that the second following drive control has been executed;
execute the first following drive control when the first energy consumption amount is equal to or less than the second energy consumption amount; and
execute the second following drive control when the second energy consumption amount is smaller than the first energy consumption amount, wherein the control device is configured to acquire the first energy consumption amount and the second energy consumption amount based on at least one of a gradient of a road on which the own vehicle is scheduled to travel, a weight of the own vehicle, and an amount of electric power consumed by the own vehicle in addition to the air resistance.

2. The vehicle driver-assistance device according to claim 1, wherein the control device is configured to:
acquire a transition of the air resistance as a first air resistance transition based on a size of the preceding vehicle, a transition of a vehicle speed of the own vehicle when it is assumed that the first following drive control has been executed, and a transition of an inter-vehicle distance when it is assumed that the first following drive control has been executed;
acquire a transition of a gradient resistance of the own vehicle as a first gradient resistance transition based on the gradient and the weight;
acquire a rolling resistance of the own vehicle as a first rolling resistance based on the weight;
acquire a transition of an acceleration resistance of the own vehicle as a first acceleration resistance transition based on the weight and a transition of an acceleration of the own vehicle when it is assumed that the first following drive control has been executed;
acquire the first energy consumption amount based on the first air resistance transition, the first gradient resistance transition, the first rolling resistance, the first acceleration resistance transition, and the amount of electric power;
acquire a transition of the air resistance as a second air resistance transition based on the size of the preceding vehicle, a transition of a vehicle speed of the own vehicle when it is assumed that the second following drive control has been executed, and a transition of the inter-vehicle distance when it is assumed that the second following drive control has been executed;
acquire a transition of the gradient resistance of the own vehicle as a second gradient resistance transition based on the gradient and the weight;
acquire a rolling resistance of the own vehicle as a second rolling resistance based on the weight;
acquire a transition of an acceleration resistance of the own vehicle as a second acceleration resistance transition based on the weight and a transition of an acceleration of the own vehicle when it is assumed that the second following drive control has been executed; and
acquire the second energy consumption amount based on the second air resistance transition, the second gradient resistance transition, the second rolling resistance, the second acceleration resistance transition, and the amount of electric power.
